(19) United States
(12) Patent Application Publication
(10) Pub. No.: US 2025/0066037 A1
(43) Pub. Date: Feb. 27, 2025

(54) ALERT DEVICE, ALERT METHOD, AND STORAGE MEDIUM

(71) Applicant: NEC Corporation, Minato- ku, Tokyo (JP)

(72) Inventors: Takanari Arai, Tokyo (JP); Eiichi Tokumi, Tokyo (JP); Kenichi Keyaki, Tokyo (JP); Eiji Ichihara, Tokyo (JP); Kensuke Uchida, Tokyo (JP); Jun Suzuki, Tokyo (JP); Takeshi Shouta, Tokyo (JP); Kenichi Sakamoto, Tokyo (JP)

(73) Assignee: NEC Corporation, Minato- ku, Tokyo (JP)

(21) Appl. No.: 18/726,164

(22) PCT Filed: Jan. 28, 2022
(86) PCT No.: PCT/JP2022/003227

§ 371 Date: Jul. 2, 2024

(51) Int. Cl. B64D 47/06; G06V 20/00; G08G 5/00

(52) U.S. Cl. CPC B64D 47/06; G06V 20/95; G08G 5/0004

(57) ABSTRACT

An alert device according to an aspect of the present disclosure includes: at least one memory storing a set of instructions; and at least one processor configured to execute the set of instructions to: identify, from measurement data of a flying object by a sensor, a position of the flying object; determine whether the flying object is located within a predetermined region; determine whether a signal of a predetermined pattern assigned to a mission in the predetermined region is received from the flying object determined to be located within the predetermined region; determine, in a case where no signal of the predetermined pattern is received from the flying object, that the flying object is an unpermitted flying object that is not permitted to enter the predetermined region; and cause a light projection device to irradiate a position of the unpermitted flying object with light.

### TECHNICAL FIELD

The present disclosure relates to a technique for issuing an alert, and particularly to a technique for issuing an alert related to a flying object.

### BACKGROUND ART

In recent years, flying objects such as drones have become easily available, and flying objects have come to be frequently used. However, in a case where a flying object whose entry is not permitted enters a place where some mission by the flying object is executed, such as a disaster site, there is a possibility that danger occurs and the execution of the mission is hindered.

PTL 1 discloses a management system that performs control according to attribute information about a current position of an autonomous moving body and individual information about the autonomous moving body when a traveling route of the autonomous moving body is changed from a plan.

PTL 2 describes a computer system that controls a flight of a flight vehicle in a three-dimensional space network based on region data including dynamic information indicating the three-dimensional space network and a dynamically changing situation of the three-dimensional space network.

PTL 3 describes a flight system including an output unit that outputs a prohibition signal or radiates predetermined irradiation light indicating that flight is prohibited to a flight prohibited region, and a flight vehicle that performs a hovering operation or a landing operation when receiving the prohibition signal or the predetermined radiation light.

PTL 4 describes a flight management device that transmits warning information to a vehicle at a position related to position information when receiving from the flight device position information about a flight device and notification information indicating that the flight device is likely to fall.

PTL 5 describes a system that determines whether an identifier indicated by a signal transmitted from a flight system is an identifier of a flight system permitted to fly in an airspace. The system functions to interact with elements, jamming, removing, or otherwise when the flight system is an unpermitted flight system.

### CITATION LIST

### Patent Literature

PTL 1: WO 2019/181897 A1

PTL 2: JP 2020-087145 A

PTL 3: JP 2020-001651 A

PTL 4: WO 2019/176423 A1

PTL 5: JP 2019-517083 A

### SUMMARY OF INVENTION

### Technical Problem

The techniques of PTLs 1 to 3 are techniques for controlling or managing a flying object under management. The technique of PTL 4 is a technique for making a notification of an abnormality of a flying object under control. The technique of PTL 5 can determine whether a flying object that transmits an identifier is a flying object permitted to fly in an airspace. In the techniques of PTLs 1 to 5, in a case where an unexpected flying object enters a region where work using the flying object is being performed, it is not possible to issue an alert identifying the flying object having entered the region to a person involved in the work in the region.

An object of the present disclosure is to provide an alert device or the like that can easily issue an alert to a flying object that is not scheduled to enter a predetermined region.

### Solution to Problem

An alert device according to an embodiment of the present disclosure includes a position determination means for identifying, from measurement data of a flying object by a sensor, a position of the flying object, and determining whether the flying object is located within a predetermined region, a specific information determination means for determining whether a signal of a predetermined pattern assigned to a mission within the predetermined region is received from the flying object determined to be located within the predetermined region, a permission determination means for determining, when no signal of the predetermined pattern is received from the flying object, that the flying object is an unpermitted flying object that is not permitted to enter the predetermined region, and a control means for causing a light projection device to irradiate a position of the unpermitted flying object with light.

An alert method according to an embodiment of the present disclosure includes identifying, from measurement data of a flying object by a sensor, a position of the flying object, and determining whether the flying object is located within a predetermined region, determining whether a signal of a predetermined pattern assigned to a mission within the predetermined region is received from the flying object determined to be located within the predetermined region, determining, when no signal of the predetermined pattern is received from the flying object, that the flying object is an unpermitted flying object that is not permitted to enter the predetermined region, and causing a light projection device to irradiate a position of the unpermitted flying object with light.

A storage medium according to an embodiment of the present disclosure stores a program for causing a computer to execute a position determination step for identifying, from measurement data of a flying object by a sensor, a position of the flying object, and determining whether the flying object is located within a predetermined region, a specific information determination step for determining whether a signal of a predetermined pattern assigned to a mission within the predetermined region is received from the flying object determined to be located within the predetermined region, a permission determination step for determining, when no signal of the predetermined pattern is received from the flying object, that the flying object is an unpermitted flying object that is not permitted to enter the predetermined region, and a control step for causing a light projection device to irradiate a position of the unpermitted flying object with light. An aspect of the present disclosure is also implemented by the program described above.

### Advantageous Effects of Invention

The present disclosure has an effect of easily issuing an alert to a flying object that is not scheduled to enter a predetermined region.

### BRIEF DESCRIPTION OF DRAWINGS

FIG. 1 is a block diagram illustrating an example of a configuration of an alert device according to the first example embodiment of the present disclosure.

FIG. 2 is a flowchart illustrating an example of operation of the alert device according to the first example embodiment of the present disclosure.

FIG. 3 is a block diagram illustrating an example of a configuration of an alert device according to the second example embodiment of the present disclosure.

FIG. 4 is a flowchart illustrating an example of the overall operation of the alert device according to the second example embodiment of the present disclosure.

FIG. 5 is a flowchart illustrating an example of an operation of the detection process of the alert device according to the second example embodiment of the present disclosure.

FIG. 6 is a flowchart illustrating an operation of the determination process of the alert device according to the second example embodiment of the present disclosure.

FIG. 7 is a diagram illustrating an example of a hardware configuration of a computer that can implement the alert device according to the example embodiment of the present disclosure.

FIG. 8 is a diagram schematically illustrating an annular range where the flying object can exist.

FIG. 9 is a view illustrating an example of a shape of a reflection site.

### EXAMPLE EMBODIMENT

Hereinafter, example embodiments of the present disclosure will be described in detail with reference to the drawings.

### First Example Embodiment

First, the first example embodiment of the present disclosure will be described in detail with reference to the drawings.

### <Configuration>

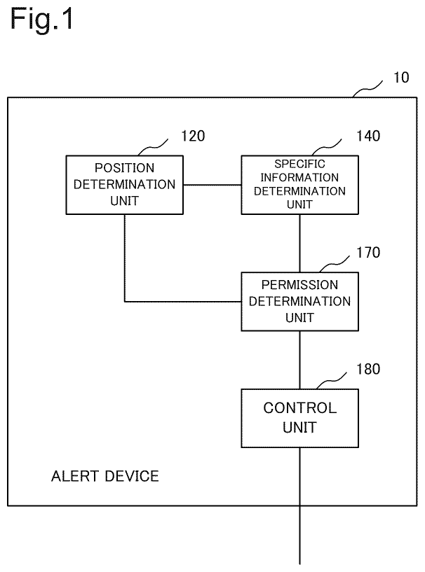

FIG. 1 is a block diagram illustrating an example of a configuration of an alert device 10 according to the first example embodiment of the present disclosure. In the example illustrated in FIG. 1, the alert device 10 according to the present example embodiment includes a position determination unit 120, a specific information determination unit 140, a permission determination unit 170, and a control unit 180. The position determination unit 120 determines whether the flying object is located in a predetermined region from measurement data of the flying object by the sensor. The specific information determination unit 140 determines whether a signal of a predetermined pattern assigned to a mission in the predetermined region has been received from the flying object determined to be located in the predetermined region. When not receiving the signal of the predetermined pattern from the flying object, the permission determination unit 170 determines that the flying object is an unpermitted flying object that is not permitted to enter the predetermined region. The control unit 180 causes the light projection device to irradiate the unpermitted flying object with light.

The predetermined region described above is, for example, above a region where a disaster has occurred. For example, the administrator of the predetermined region permits a flying object performing a mission in the predetermined region to enter the predetermined region. The height of the predetermined region may be appropriately determined.

The sensor of the present example embodiment is, for example, a plurality of imaging devices installed in such a way as to be able to image a flying object flying in the predetermined region described above. The positions of the plurality of imaging devices, the directions of the optical axes, the camera parameters, and the like are obtained in advance by measurement, calibration, and the like. The position of the imaging device, the direction of the optical axis, and the like may be determined in a coordinate system appropriately defined in advance in the three-dimensional space. The position of the imaging device may be represented by a latitude, a longitude, and a height from the sea face.

In the present example embodiment, a flying object to which a mission in a predetermined region is assigned and that is permitted to enter the predetermined region is configured to emit a signal of a predetermined pattern (hereinafter, also referred to as a specific signal). The signal of the predetermined pattern is a signal different from the signal indicating the identifier of the flying object. The specific signal may be, for example, light blinking in a specific pattern emitted by a light emitting element such as a light emitting diode (LED) attached to the flying object. Another example of the signal of the predetermined pattern will be described in detail later.

### <Position Determination Unit 120>

The position determination unit 120 detects the flying object from measurement data of the flying object by the sensor, for example, a plurality of images obtained by performing imaging by the plurality of imaging devices described above. Specifically, the measurement data used by the position determination unit 120 is images captured at the same timing by at least two imaging devices. These images may be images included in the moving image. The method of detecting the flying object may be any of existing image recognition methods. The position determination unit 120 estimates the position of the detected flying object. The method of estimating the position of the detected flying object may be one of various existing methods, for example, a method of estimating a three-dimensional position of a point in an image from an image captured by a stereo camera.

### <Specific Information Determination Unit 140>

The specific information determination unit 140 determines whether a signal (that is, the above-described specific signal) of a predetermined pattern assigned to the mission in the predetermined region has been received from the flying object determined to be located in the predetermined region, using the measurement data of the flying object. In a case where the specific signal is light blinking in a specific pattern emitted by the light emitting element attached to the flying object, the measurement data used by the specific information determination unit 140 is, for example, a moving image of the flying object determined to be located within a predetermined region, the moving image being captured by the imaging device. The imaging device that captures the moving image may be one of the plurality of imaging devices described above. The imaging device that captures the moving image may be an imaging device different from the plurality of imaging devices described above. The imaging device that captures the moving image may be, for example, an imaging device configured to track the flying object determined to be located within the predetermined region. The method of tracking the flying object may be one of various existing methods.

The specific information determination unit 140 may detect a region of blinking light in the moving image of the flying object determined to be located in the predetermined region, and determine whether the pattern of blinking of light is a specific pattern in the detected region.

### <Permission Determination Unit 170>

When not receiving the signal of the predetermined pattern from the flying object determined to be located in the predetermined region, the permission determination unit 170 determines that the flying object is an unpermitted flying object that is a flying object that is not permitted to enter the predetermined region. For example, when a region where light blinks in a specific pattern is not detected in the moving image of the flying object determined to be located in the predetermined region, the permission determination unit 170 determines that the flying object is an unpermitted flying object.

When receiving a signal of a predetermined pattern from the flying object determined to be located in the predetermined region, the permission determination unit 170 may determine that the flying object is a permitted flying object permitted to enter the predetermined region. For example, when a region in which light blinks in a specific pattern is detected in the moving image of the flying object determined to be located in the predetermined region, the permission determination unit 170 may determine that the flying object is a permitted flying object.

### <Control Unit 180>

The control unit 180 causes a light projection device such as a search light to irradiate the unpermitted flying object with light.

The control unit 180 may be connected to, for example, a light projection control device that controls a direction in which the light projection device radiates light. The control unit 180 transmits, to the light projection control device, a control instruction indicating an instruction to cause the light projection device to irradiate the unpermitted flying object with light. The light projection control device receives the control instruction, and causes the light projection device to irradiate the unpermitted flying object with light according to the received control instruction. As a result, the unpermitted flying object is irradiated with light. In this manner, the control unit 180 controls the light projection device by transmitting the control instruction to the light projection control device that controls the light projection device. The control unit 180 may include the function of the light projection control device.

Hereinafter, a specific example of control by a control instruction will be described. The light projection control device may be configured to control the radiation direction in which the light projection device radiates the light in such a way that the light radiated by the light projection device is directed to the coordinates when receiving the coordinates to be irradiated in the coordinates set in the light projection device. The coordinate system used by the light projection control device may be the same as the coordinate system (that is, the coordinate system of the coordinates representing the position of the flying object calculated by the position determination unit 120) used by the position determination unit 120. In a case where the coordinate system used by the light projection control device is different from the coordinate system used by the position determination unit 120, the control unit 180 holds in advance a parameter representing conversion from coordinates in the coordinate system used by the position determination unit 120 to coordinates in the coordinate system used by the light projection control device. Then, using the parameter, the control unit 180 converts the coordinates representing the position of the flying object calculated by the position determination unit 120 into the coordinates in the coordinate system used by the light projection control device. Then, the control unit 180 transmits a control instruction including information about coordinates representing the position of the flying object in the coordinate system used by the light projection control device to the light projection control device. When receiving a control instruction including information about coordinates representing the position of the flying object, the light projection control device causes the light projection device to radiate the light toward the position represented by the coordinates.

The light projection control device may be configured to control the direction in which the light projection device radiates the light in such a way that the light radiated by the light projection device is directed from the start point of the light projection to the direction indicated by the direction information when receiving the direction information indicating the direction in which the light projection device radiates the light in the coordinates set in the light projection device. In this case, the control unit 180 holds the position (Specifically, the coordinates of the start point of the light projection) of the light projection device in advance. Then, the control unit 180 calculates a direction from the position of the light projection device toward the position of the unpermitted flying object. In a case where the coordinate system used by the light projection control device is the same as the coordinate system (that is, the coordinate system of the coordinates representing the position of the flying object calculated by the position determination unit 120) used by the position determination unit 120, the control unit 180 transmits the information indicating the calculated direction to the light projection control device as it is. In a case where the coordinate system used by the light projection control device is different from the coordinate system used by the position determination unit 120, the control unit 180 converts information indicating the calculated direction into information indicating the direction in the coordinate system used by the light projection control device using the above-described parameter. In this case, the control unit 180 transmits a control instruction including information indicating the converted direction to the light projection control device. The light projection control device controls the direction in which the light projection device radiates the light in such a way that the light radiated by the light projection device is directed from the start point of the light projection to the direction indicated by the direction information when receiving the control instruction including the direction information indicating the direction in which the light projection device radiates the light in the coordinates set in the light projection device.

The light radiated by the light projection device may be light having brightness that is easily visible even in a bright place. The light projection device may radiate light blinking in a predetermined pattern, for example. For example, the light projection device may change the color of the light radiated in a predetermined pattern. The light projection device may change, for example, the color and brightness of the light to be radiated in a predetermined pattern.

### <Operation>

Next, an operation of the alert device 10 according to the first example embodiment of the present disclosure will be described in detail with reference to the drawings.

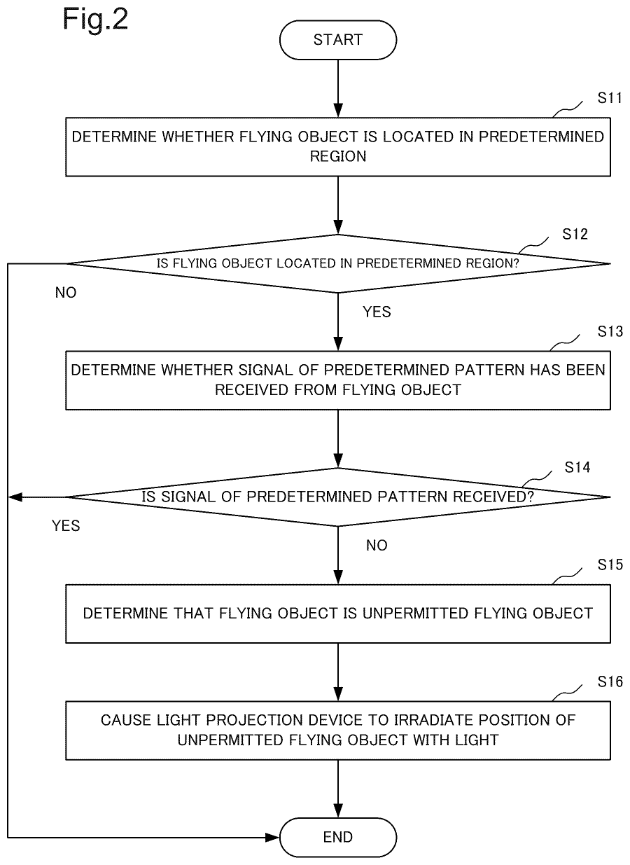

FIG. 2 is a flowchart illustrating an example of the operation of the alert device 10 according to the first example embodiment of the present disclosure. In the example illustrated in FIG. 2, first, the position determination unit 120 determines whether the flying object is located in the predetermined region from the measurement data of the flying object (step S11). When the flying object is not located within the predetermined region (NO in step S12), the operation of the alert device 10 of the present example embodiment ends. When the flying object is located in the predetermined region (YES in step S12), the specific information determination unit 140 determines whether a signal of a predetermined pattern has been received from the flying object (step S13). When the signal of the predetermined pattern is received from the flying object (YES in step S14), the alert device 10 of the present example embodiment ends the operation illustrated in FIG. 2. When the signal of the predetermined pattern is not received from the flying object (NO in step S14), the permission determination unit 170 determines that the flying object is an unpermitted flying object (step S15). Then, the control unit 180 causes the light projection device to irradiate the unpermitted flying object with light (step S16).

### <Effects>

The present example embodiment has an effect of easily issuing an alert to a flying object that is not scheduled to enter a predetermined region. This is because the specific information determination unit 140 determines whether a signal of a predetermined pattern assigned to the mission in the predetermined region has been received from the flying object determined to be located in the predetermined region. Then, this is because the permission determination unit 170 determines that the flying object is an unpermitted flying object that is not permitted to enter the predetermined region when not receiving the signal of the predetermined pattern from the flying object. In addition, this is because the control unit 180 causes the light projection device to irradiate the unpermitted flying object with light. As a result, a person at a position where the unpermitted flying object can be visually recognized can confirm the position of the unpermitted flying object that is not permitted to enter the predetermined region and is not scheduled to enter the predetermined region. For example, in a case where information about an unpermitted flying object is notified to a portable terminal device, it is not easy to issue an alert to the unpermitted flying object to a person who does not hold the portable terminal. However, when the unpermitted flying object is irradiated with light, even a person who does not hold a portable terminal can easily know the presence and position of the unpermitted flying object. In this way, by irradiating the unpermitted flying object with light, it is easy to issue an alert to a person who is at a place where the unpermitted flying object can be visually recognized.

### Second Example Embodiment

Next, the second example embodiment of the present disclosure will be described in detail with reference to the drawings.

### <Configuration>

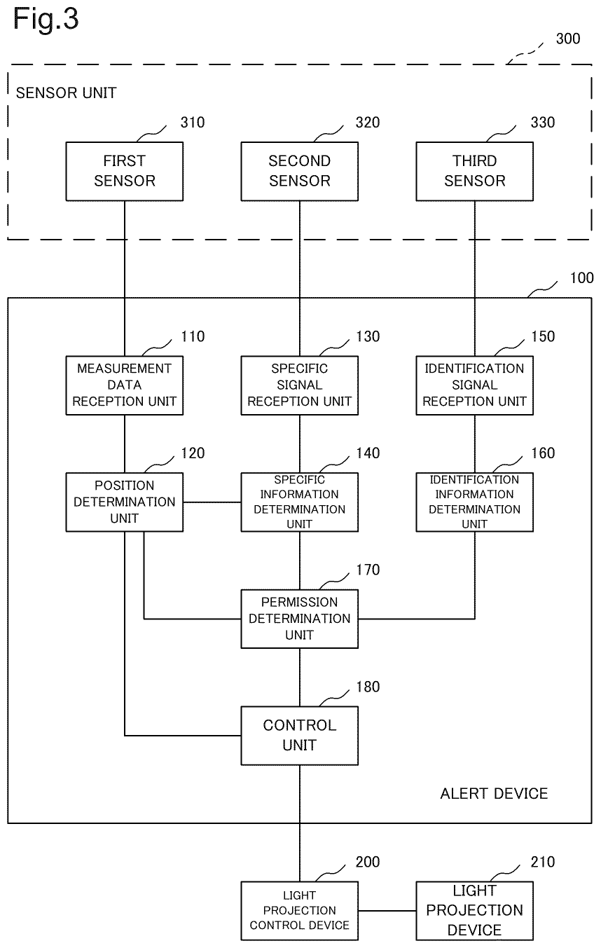

FIG. 3 is a block diagram illustrating an example of a configuration of an alert device 100 according to the second example embodiment of the present disclosure. In the example illustrated in FIG. 3, the alert device 100 includes a measurement data reception unit 110, a position determination unit 120, a specific signal reception unit 130, a specific information determination unit 140, an identification signal reception unit 150, an identification information determination unit 160, a permission determination unit 170, and a control unit 180. The alert device 100 is communicably connected to a first sensor 310, a second sensor 320, and a third sensor 330. The first sensor 310, the second sensor 320, and the third sensor 330 are also collectively referred to as a sensor unit 300. The alert device 100 is further communicably connected to a light projection control device 200. The light projection control device 2000 is communicably connected to a light projection device 210. Among the components of the present example embodiment, the same components as those of the first example embodiment are given the same names and reference numerals as those given to the components of the first example embodiment.

In the following description, the predetermined region is the same as the predetermined region of the first example embodiment. That is, the predetermined region is, for example, above a region where a disaster has occurred. For example, the administrator of the predetermined region permits a flying object performing a mission in the predetermined region to enter the predetermined region. The height of the predetermined region may be appropriately determined.

Also in the present example embodiment, a flying object to which a mission in a predetermined region is assigned and that is permitted to enter the predetermined region is configured to emit a signal of a predetermined pattern (that is, the specific signal). As described above, the signal of the predetermined pattern is a signal different from the signal indicating the identifier of the flying object. As described above, the specific signal may be, for example, light blinking in a specific pattern emitted by a light emitting element such as an LED attached to the flying object.

In the present example embodiment, at least some of the flying objects wirelessly transmits an identification signal indicating identification information given to each flying object. A mechanism for wirelessly transmitting an identification signal indicating identification information is generally called remote identification (ID).

### <Sensor Unit 300>

### <First Sensor 310>

The first sensor 310 is related to the sensor of the first example embodiment. That is, the first sensor 310 is, for example, a plurality of imaging devices installed in such a way as to be able to image a flying object flying in the predetermined region described above. The plurality of imaging devices as the first sensor 310 may be configured to capture images at the same timing. The plurality of imaging devices as the first sensor 310 may be configured to capture a moving image.

### <Second Sensor 320>

In the present example embodiment, the second sensor 320 captures a moving image of the flying object. The second sensor 320 may be the same imaging device as the first sensor 310. The second sensor 320 may be an imaging device different from the first sensor 310. Each of the imaging devices as the second sensor 320 may be configured to track one of the imaging devices located in the predetermined region.

<Third sensor 330>

The third sensor 330 is a sensor that receives an identification signal indicating identification information about the flying object, the identification signal being wirelessly transmitted from the flying object. A plurality of third sensors may be installed in the predetermined region. The position where the third sensor is installed may be measured in advance and given to the alert device 100.

### <Alert Device 100>

### <Measurement Data Reception Unit 110>

The measurement data reception unit 110 receives the measurement data (as described above, images captured by a plurality of imaging devices at the same timing) measured by the first sensor 310 from the first sensor 310. The measurement data reception unit 110 transmits the received measurement data to the position determination unit 120.

### <Position Determination Unit 120>

The position determination unit 120 receives the measurement data from the measurement data reception unit 110. The position determination unit 120 estimates the position of the flying object using the measurement data, as in the position determination unit 120 of the first example embodiment. The position determination unit 120 determines whether the estimated position of the flying object is included in the predetermined region. The position determination unit 120 transmits the estimated position (specifically, information indicating the position) of the flying object determined to be located within the predetermined region to the permission determination unit 170.

The position determination unit 120 further transmits information indicating the flying object determined to be located in the predetermined region to the specific information determination unit 140. The information indicating the flying object determined to be located within the predetermined region includes information indicating an estimated position of the flying object. In a case where the first sensor 310 is the same imaging device as the second sensor 320, the information indicating the flying object determined to be located within the predetermined region may include information indicating a region of the flying object in the image in which the flying object is imaged.

### <Specific Signal Reception Unit 130>

The specific signal reception unit 130 receives, from the second sensor 320, measurement data (specifically, for example, a moving image) of the flying object located in the predetermined region, the flying object being captured by the second sensor 320. The specific signal reception unit 130 transmits the received moving image to specific information determination unit 140.

### <Specific Information Determination Unit 140>

The specific information determination unit 140 receives the moving image of the flying object located in the predetermined region from the specific signal reception unit 130. The specific information determination unit 140 further receives information indicating the flying object determined to be located within the predetermined region from the position determination unit 120. The specific information determination unit 140 identifies the flying object determined to be located in the predetermined region in the received moving image using the received information indicating the flying object determined to be located in the predetermined region. In a case where the information indicating the flying object determined to be located in the predetermined region is information indicating the position of the flying object, the specific information determination unit 140 identifies the flying object determined to be located in the predetermined region in the received moving image from the position of the flying object and the information indicating the imaging range of the second sensor 320. In a case where the first sensor 310 is the same imaging device as the second sensor 320, and the information indicating the flying object determined to be located in the predetermined region is the information indicating the region of the flying object in the captured image, the specific information determination unit 140 uses the received information indicating the region of the flying object as it is.

The specific information determination unit 140 determines whether a signal of a predetermined pattern is emitted from the flying object located in the predetermined region. As described above, in the present example embodiment, the signal of the predetermined pattern, that is, the specific signal is light blinking in the predetermined pattern emitted by the light emitting element. For example, the specific information determination unit 140 may track the region of the flying object in the moving image of the flying object. Then, specific information determination unit 140 may detect a partial region that blinks in a predetermined pattern in the region of the flying object being tracked. When a partial region blinking in a predetermined pattern is detected in the region of the flying object being tracked, the specific information determination unit 140 may determine that a signal of a predetermined pattern is emitted from the flying object. The specific information determination unit 140 transmits, to the permission determination unit 170, information about the position of the flying object determined to have emitted a signal of a predetermined pattern and information about the position of the flying object determined not to have emitted a signal of a predetermined pattern.

### <Identification Signal Reception Unit 150>

The identification signal reception unit 150 receives, from the third sensor 330, an identification signal indicating identification information transmitted from the flying object and received by the third sensor 330. The identification signal reception unit 150 transmits the information about the received identification signal and the sensor identification information for identifying the third sensor 330 that has received the identification signal to the identification information determination unit 160. When the plurality of third sensors 330 receive the identification signal indicating the same identification information, the identification signal reception unit 150 transmits a combination of the information about one identification signal and the sensor identification information about the plurality of third sensors to the identification information determination unit 160. The information about the identification signal may include an identification signal indicated by the identification signal and information indicating the strength of the identification signal.

### <Identification Information Determination Unit 160>

The identification information determination unit 160 receives, from the identification signal reception unit 150, the information about the identification signal and the sensor identification information for identifying third sensor 330 that has received the identification signal. As described above, the information about the identification signal includes the identification information indicated by the identification signal. The information about the identification signal may include information indicating the strength of the identification signal.

The identification information determination unit 160 estimates, from the sensor identification information for identifying the third sensor 330 that has received the identification signal and the position of the third sensor 330, an existence possible range that is a range in which the flying object that has transmitted the identification signal is likely to be located. In this case, for example, the identification information determination unit 160 may set a range in which a distance from the third sensor 330 identified by the sensor identification information is within a distance the identification signal that can be received by the third sensor 330 reaches as the existence possible range.

The identification information determination unit 160 may regard the predetermined region as a plane. The identification information determination unit 160 may assume that the flying object is flying at a predetermined height. In this case, the identification information determination unit 160 may calculate a distance at which, theoretically, an identification signal having a strength same as a strength of the identification signal included in the information about the identification signal is observed when the flying object is flying at a predetermined height. The identification information determination unit 160 may evaluate the calculated distance error using a method appropriately determined in advance. In other words, the identification information determination unit 160 may estimate the maximum value and the minimum value of the distance to the flying object in a case where the error is taken into consideration. The identification information determination unit 160 may set a circle obtained by projecting a circle whose height is a predetermined height and whose distance from the third sensor 330 is the minimum value of the estimated distance on a plane representing a predetermined region as the inner circumference of the existence possible amount range. The identification information determination unit 160 may set a circle obtained by projecting a circle whose height is a predetermined height and whose distance from the third sensor 330 is the maximum value of the estimated distance on a plane representing a predetermined region as the outer circumference of the existence possible amount range.

The identification information determination unit 160 may set the range of the height at which the flying object flies as a predetermined range. A minimum value of a predetermined range of the height is referred to as a minimum height, and a maximum value of the predetermined range of the height is referred to as a maximum height. In this case, the identification information determination unit 160 may calculate a circle in which the flying object can exist in a case where the altitude at which the flying object flies is the minimum height, and the distance from the third sensor 330 to the flying object is a distance at which the identification signal having a strength same as a strength of the identification signal included in the information about the identification signal is observed. The identification information determination unit 160 may set a circle obtained by projecting the calculated circle on a plane representing a predetermined region as the outer circumference of the existence possible amount range. The identification information determination unit 160 may calculate a circle in which the flying object can exist in a case where the altitude at which the flying object flies is the maximum height, and the distance from the third sensor 330 to the flying object is a distance at which the identification signal having a strength same as a strength of the identification signal included in the information about the identification signal is observed. The identification information determination unit 160 may set a circle obtained by projecting the calculated circle on a plane representing a predetermined region as the inner circumference of the existence possible amount range.

Also in this case, the identification information determination unit 160 may evaluate the distance error. In this case, as described above, the identification information determination unit 160 may estimate the maximum value and the minimum value of the distance to the flying object (that is, the distance at which the identification signal having a strength same as a strength of the identification signal included in the information about the identification signal is observed) in a case where the error is taken into consideration. In this case, the identification information determination unit 160 may calculate a circle in which the flying object can exist in a case where the height at which the flying object flies is the minimum height, and the distance from the third sensor 330 to the flying object is the maximum value of the distance to the flying object in a case where the error is taken into consideration. The identification information determination unit 160 may set a circle obtained by projecting the calculated circle on a plane representing a predetermined region as the outer circumference of the existence possible amount range. The identification information determination unit 160 may calculate a circle in which the flying object can exist in a case where the height at which the flying object flies is the maximum height and the distance from the third sensor 330 to the flying object is the minimum value of the distance in consideration of the error. The identification information determination unit 160 may set a circle obtained by projecting the calculated circle on a plane representing a predetermined region as the inner circumference of the existence possible amount range.

The method of calculating the existence possible range is not limited to the above example.

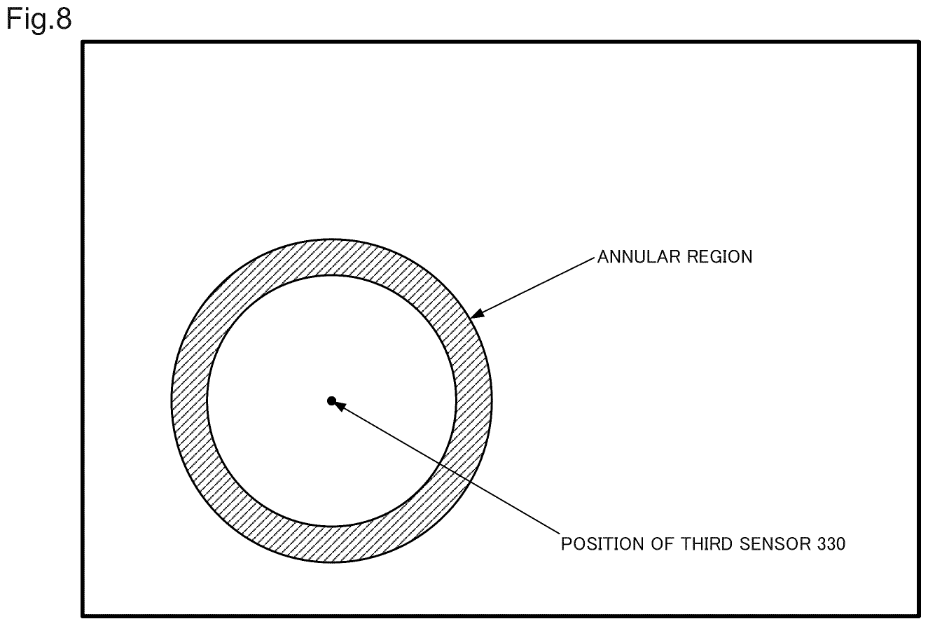

FIG. 8 is a diagram schematically illustrating an annular existence possible range of the flying object. In the example illustrated in FIG. 8, the inside of the rectangular rectangle is the above-described predetermined region. A hatched region is an existence possible range.

In a case where the number of the third sensors 330 that has received the identification signal is one, and the information about the identification signal includes information indicating the strength of the identification signal, the identification information determination unit 160 may determine the existence possible range as follows, for example.

The identification information determination unit 160 may set the sensor identification information for identifying the third sensor 330 that has received the identification signal and a range in which the strength of the identification signal from the flying object can be the strength of the identification signal included in the information about the identification signal at the position of the third sensor 330 as the existence possible range. Specifically, for example, the identification information determination unit 160 may calculate a distance at which the strength of the transmitted identification signal is a strength of the detected identification signal by attenuation. The identification information determination unit 160 may set an annular region in which the distance from the position of the third sensor 330 includes a circle of the calculated distance and has a width determined by an appropriately determined method as the existence possible range.

When the plurality of third sensors 330 receive the identification signal, the identification information determination unit 160 may calculate the existence possible range using the strengths of the identification signal received by the plurality of third sensors. In this case, for example, the identification information determination unit 160 may calculate the above-described annular region for each of the plurality of third sensors 330, and set a common portion of the plurality of calculated annular regions as the existence possible range.

The identification information determination unit 160 may estimate the existence possible range by another method.

The identification information determination unit 160 transmits the identification information about the flying object and the range in which the flying object to which the identification information is assigned can exist to the permission determination unit 170.

### <Permission Determination Unit 170>

The permission determination unit 170 receives, from the specific information determination unit 140, information about the position of the flying object determined to have emitted a signal of a predetermined pattern and information about the position of the flying object determined not to have emitted a signal of a predetermined pattern.

The permission determination unit 170 receives the identification information about the flying object and the range in which the flying object to which the identification information is assigned can exist from the identification information determination unit 160.

The permission determination unit 170 may receive the estimated position of the flying object determined to be located within the predetermined region from the position determination unit 120.

The permission determination unit 170 determines whether the received identification information about the flying object is included in the list of identification information about the flying object to which the mission in the predetermined region is assigned. The list of identification information about the flying object to which the mission in the predetermined region is assigned (hereinafter, referred to as a permission list) may be given to the permission determination unit 170 in advance.

The permission determination unit 170 associates the identification information indicated by the identification signal transmitted from the flying object included in the existence possible range with the flying object included in the existence possible range received from the identification information determination unit 160 among the flying objects whose positions are received from the specific information determination unit 140. The permission determination unit 170 may associate the plurality of pieces of identification information with the flying object of the plurality of pieces of identification information included in the existence possible range.

When a signal of a predetermined pattern is emitted from the flying object determined to be located in the predetermined region, the permission determination unit 170 determines that the flying object is a permitted flying object. When a signal of a predetermined pattern is not emitted from the flying object determined to be located in the predetermined region and identification information that is not included in the permission list is associated with the flying object, the permission determination unit 170 determines that the flying object is an unpermitted flying object. When the signal of the predetermined pattern is not emitted from the flying object determined to be located in the predetermined region and the identification information included in the permission list is associated with the flying object, the permission determination unit 170 determines that the flying object is a permitted flying object. When the signal of the predetermined pattern is not emitted from the flying object determined to be located in the predetermined region and the identification information is not associated with the flying object, the permission determination unit 170 determines that the flying object is an unpermitted flying object.

When there is a flying object determined to be an unpermitted flying object, the permission determination unit 170 transmits information about the position of the flying object determined to be the unpermitted flying object to the control unit 180. When there is the flying object determined to be the permitted flying object, the permission determination unit 170 may transmit information about the position of the flying object determined to be the permitted flying object to the control unit 180.

### <Control Unit 180>

When there is a flying object determined to be an unpermitted flying object, the control unit 180 receives information about the position of the flying object determined to be the unpermitted flying object from the permission determination unit 170. When there is the flying object determined to be the permitted flying object, the control unit 180 receives information about the position of the flying object determined to be the permitted flying object from the permission determination unit 170.

As in the control unit 180 of the first example embodiment, the control unit 180 causes a light projection device such as a search light to irradiate an unpermitted flying object with light. The control unit 180 may be connected to, for example, a light projection control device that controls a direction in which the light projection device radiates light. The control unit 180 transmits, to the light projection control device, the above-described control instruction indicating an instruction to cause the light projection device to irradiate the unpermitted flying object with light. The light projection control device receives the control instruction, and causes the light projection device to irradiate the unpermitted flying object with light according to the received control instruction. As a result, the unpermitted flying object is irradiated with light.

### <Light Projection Control Device 200>

The light projection control device 200 receives the control instruction from the control unit 180, and controls the light projection device 210 according to the received control instruction. In the present example embodiment, the light projection control device 200 controls the light projection device 210 in such a way that the light projection device 210 irradiates the position of the unpermitted flying object with light according to the control instruction.

### <Operation>

Next, an operation of the alert device 100 according to the second example embodiment of the present disclosure will be described in detail with reference to the drawings.

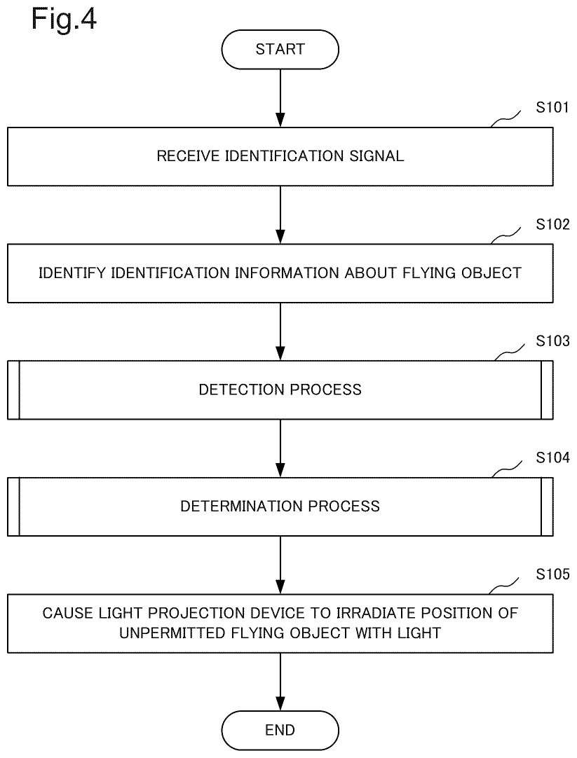

FIG. 4 is a flowchart illustrating an example of the overall 0 operation of the alert device 100 according to the second example embodiment of the present disclosure.

In the example illustrated in FIG. 4, first, the identification signal reception unit 150 receives the identification signal (step S101). Next, the identification information determination unit 160 identifies identification information about the flying object (step S102). In step S102, the identification information determination unit 160 may calculate a range in the presence of the flying object.

Then, the alert device 100 executes a detection process (step S103). By the detection process in step S103, the position of the flying object is detected from the measurement data by the first sensor 310. Then, the alert device 100 executes a determination process (step S104). By the determination process of step S104, whether the detected flying object is an unpermitted flying object or a permitted flying object is determined. The detection process and the determination process will be described in detail later.

Then, the control unit 180 causes the light projection device to irradiate the position of the unpermitted flying object with light (specifically, for example, transmit a control instruction for causing the light projection device to irradiate the position of the unpermitted flying object with light to the light projection control device 200 that controls the direction in which the light projection device radiates the light) (step S105).

The alert device 100 may repeat the operation illustrated in FIG. 4 until the unpermitted flying object is no longer detected in the predetermined region. As a result, the light projection device 210 continues to irradiate the unpermitted flying object with light.

Next, the detection process and the determination process will be described.

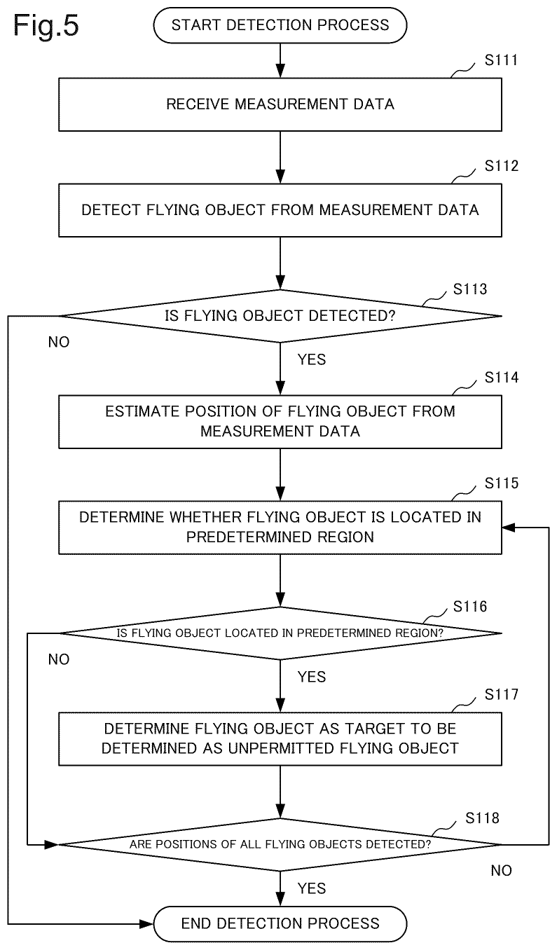

FIG. 5 is a flowchart illustrating an example of an operation of the detection process of the alert device 100 according to the second example embodiment of the present disclosure.

In the example illustrated in FIG. 5, the measurement data reception unit 110 receives the measurement data (step S111).

Specifically, the measurement data is, for example, an image captured by the first sensor 310 that is an imaging device. Next, the position determination unit 120 detects the flying object from the measurement data (step S112). When the flying object is not detected (NO in step S113), the alert device 100 ends the operation illustrated in FIG. 5.

When the flying object is detected (YES in step S113), the position determination unit 120 estimates the position of the flying object from the measurement data. Specifically, the position determination unit 120 estimates the position of the flying object appearing in the plurality of images from the plurality of images captured by the plurality of first sensors 310. The position determination unit 120 determines whether the estimated position of the flying object is included in the predetermined region. In other words, the position determination unit 120 determines whether the detected flying object is located in the predetermined region (step S115). In a case where a plurality of flying objects is detected, the position determination unit 120 selects one flying object from the detected flying objects and performs the operation of step S115 on the selected flying object. When the flying object is not located within the predetermined region (NO in step S115), the operation of the alert device 100 proceeds to step S118.

When the flying object is located in the predetermined region (YES in step S116), the position determination unit 120 determines the flying object as a target to be determined as the unpermitted flying object (step S117). When there is a flying object whose position has not been determined in the detected flying object, specifically, when there is a flying object whose position has not been determined to be within the predetermined region in the detected flying object (YES in step S118), the operation of the alert device 100 returns the process to step S115.

In a case where the positions of all the detected flying objects have been determined, specifically, in a case where it has been determined whether the positions of all the detected flying objects are located within the predetermined region (YES in step S118), the alert device 100 ends the operation illustrated in FIG. 5.

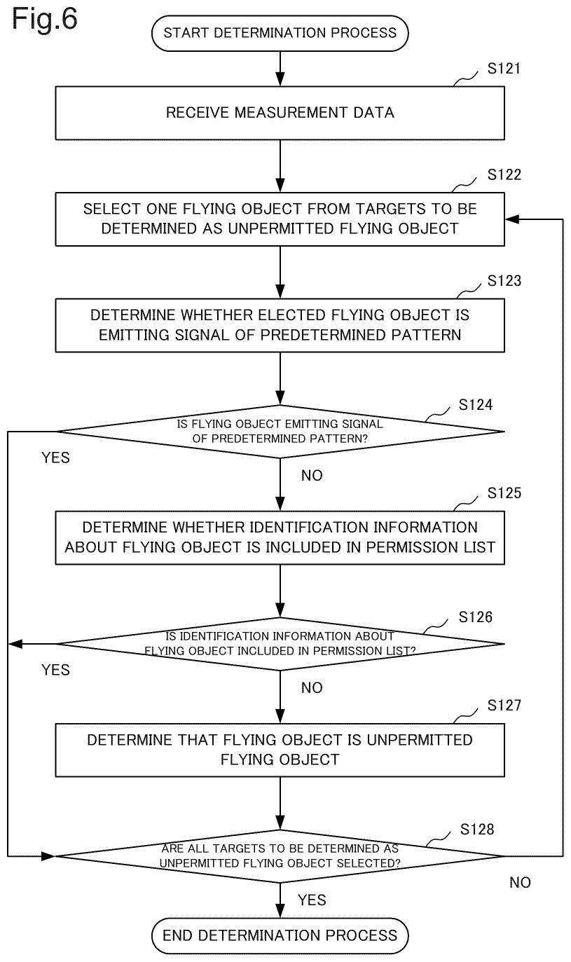

FIG. 6 is a flowchart illustrating an operation of the determination process of the alert device 100 according to the second example embodiment of the present disclosure.

In the example illustrated in FIG. 6, first, the specific signal reception unit 130 receives the measurement data of the flying object (step S121). Specifically, the specific signal reception unit 130 receives, from the second sensor 320 as measurement data of the flying object, a moving image obtained by imaging the flying object determined to be the target to be determined as the unpermitted flying object by the second sensor 320 as the imaging device.

Next, the specific information determination unit 140 selects one flying object from the targets to be determined as the unpermitted flying object (step S122). Then, the specific information determination unit 140 determines whether the selected flying object is emitting a signal of a predetermined pattern (step S123). Specifically, the specific information determination unit 140 detects a signal (for example, a region blinking in a predetermined pattern) of a predetermined pattern in a region of the flying object of the moving image in which the selected flying object is imaged, the moving image being received as the measurement data. When a signal of a predetermined pattern (that is, the specific signal) is detected in the region of the flying object of the moving image in which the selected flying object is imaged, the specific information determination unit 140 determines that the selected flying object is emitting a signal of a predetermined pattern. When a signal of a predetermined pattern (that is, the specific signal) is not detected in the region of the flying object of the moving image in which the selected flying object is imaged, the specific information determination unit 140 determines that the selected flying object does not emit a signal of a predetermined pattern. When the flying object is emitting a signal of a predetermined pattern (YES in step S124), the operation of the alert device 100 proceeds to step S128.

When the flying object does not emit the signal of the predetermined pattern (NO in step S124), the permission determination unit 170 determines whether the identification information about the flying object is included in the permission list (step S125). In step S125, the permission determination unit 170 identifies the identification information about the existence possible range including the position of the flying object determined not to emit the signal of the predetermined pattern. The permission determination unit 170 determines whether the identified identification information is included in a permission list (that is, a list of identification information about the flying object permitted to enter the predetermined region) of the identification information. In a case where the position of the flying object is included in the existence possible ranges of the plurality of pieces of identification information, the permission determination unit 170 identifies the plurality of pieces of identification information. In this case, when all the identified identification information is included in the permission list, the permission determination unit 170 may determine that the identification information about the flying object is included in the permission list. When at least one of the identified identification information is not included in the permission list, the permission determination unit 170 may determine that the identification information about the flying object is not included in the permission list. In a case where there is no identification information in which the position of the flying object is included in the existence possible range, the permission determination unit 170 determines that the identification information about the flying object is not included in the permission list.

When the identification information about the flying object is included in the permission list (YES in step S126), the operation of the alert device 100 proceeds to step S128. The permission determination unit 170 may determine a flying object that has not been determined to be an unpermitted flying object as a permitted flying object. When the identification information about the flying object is not included in the permission list, the permission determination unit 170 determines that the flying object is an unpermitted flying object (step S127). When there is an unselected target to be determined as the unpermitted flying object (NO in step S128), the operation of the alert device 100 returns to step S122. When all the targets to be determined as the unpermitted flying object have been selected (YES in step S128), the alert device 100 ends the operation illustrated in FIG. 6.

### <Effects>

The present example embodiment has the effect same as that of the first example embodiment. The reason is the same as the reason why the effect of the first example embodiment occurs.

### Example of Signal of Predetermined Pattern

In the example of the second example embodiment, the signal of the predetermined pattern (that is, the specific signal) is a blinking pattern of light emitted by one light emitting element, but the predetermined pattern is not limited to this example. The signal of the predetermined pattern may be a blinking pattern of the plurality of light emitting elements. In this case, the blinking pattern of the plurality of light emitting elements may be different for respective light emitting elements. The signal of the predetermined pattern may be light emission pattern of a plurality of light emitting elements disposed in linear, in curve, or on a plane. The light emission pattern in this case may be a pattern of an array of light emitting elements that emit light. The light emission pattern in this case may be a color pattern emitted by the light emitting element. The light emission pattern in this case may be a pattern of intensity of light emitted by the light emitting element. The light emission pattern in this case may be a pattern of a combination of at least any of an array of the light emitting elements emitting light, a color emitted by the light emitting elements, and intensity of light emitted by the light emitting element. The light emitting element may continue to emit light with the same brightness without blinking. The light emission pattern may be a pattern of a change in at least any one of an array of light emitting elements emitting light, a color emitted by the light emitting element, and intensity of light emitted by the light emitting element.

The signal of the predetermined pattern may have, for example, a shape of a reflection site that reflects light of a predetermined wavelength. In this case, a predetermined shaped reflection site that reflects light having a predetermined wavelength may be attached to the permitted flying object. The predetermined shaped reflection site may be a predetermined shaped portion of a figure drawn on a seal, a plate, or the like with a coating material or the like that reflects light having a predetermined wavelength. A certificate for irradiating a flying object flying in a predetermined region with light having a predetermined wavelength may be installed. The light of the predetermined wavelength is different from the light with which the unpermitted flying object is irradiated. The light having the predetermined wavelength may not be visible light. The intensity of the light having the predetermined wavelength may be lower than the intensity of the light with which the unpermitted flying object is irradiated. A search light that irradiates the flying object detected by the position determination unit 120 with light having a predetermined wavelength may be installed. Such a search light may be controlled by, for example, a device that receives the position of the flying object detected from the position determination unit 120 of the alert device 100 and controls the radiation direction of the search light in such a way that the region including the received position of the flying object is irradiated with the light of the search light.

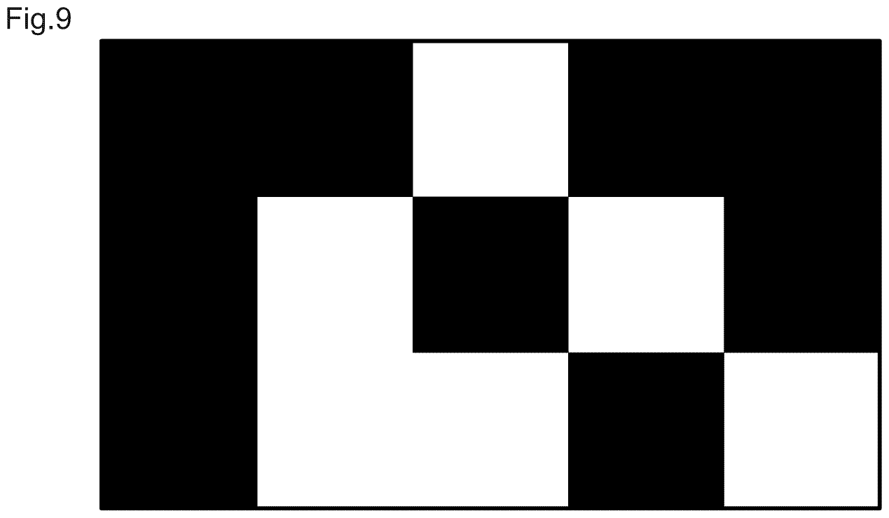

FIG. 9 is a diagram illustrating an example of the shape of the reflection site. In the example illustrated in FIG. 14, a rectangle on the outer circumference represents a member such as a seal or a plate on which the reflection site is drawn. The black portion represents a reflection site that reflects light having a predetermined wavelength. The figure illustrated in FIG. 14 is merely an example. The shape of the reflection site is not limited to the figure illustrated in FIG. 9.

### First Modification of Second Example Embodiment

A plurality of light projection devices 210 that can irradiate the flying object in the predetermined region with light may be installed. Each of the plurality of light projection devices 210 may be installed in such a way as to be able to irradiate the flying object existing in at least part of the predetermined region with light. The light projection control device 200 capable of controlling the direction in which the plurality of light projection devices 210 radiates light may be communicably connected to the alert device 100. In the description of the present modification, the number of the light projection control devices 200 is one, but a plurality of light projection control devices 200 each capable of controlling one or more light projection devices 210 may be communicably connected to the alert device 100.

The control unit 180 may hold information about a range that the plurality of light projection devices 210 can irradiate with light. The control unit 180 may select, from the plurality of light projection devices 210, the light projection device 210 including the information about the unpermitted flying object in the range that the light projection device can irradiate with light, that is, one or more light projection devices 210 capable of irradiating the position of the unpermitted flying object with light. The control unit 180 may select a predetermined number or less of the light projection devices 210 in descending order of distance from the unpermitted flying object. The control unit 180 generates control information about the selected light projection device 210 to transmit the generated control information to the light projection control device 200 that controls the selected light projection device 210.

When a plurality of unpermitted flying objects is detected, the control unit 180 may assign one or more light projection devices 210 to each of the detected plurality of unpermitted flying objects. In this case, the control unit 180 assigns one or more light projection devices 210 to the unpermitted flying object from among the light projection devices 210 capable of irradiating the unpermitted flying object with light, and the control unit 180 transmits, to the light projection control device 200 that controls the light projection device 210, a control instruction to cause the light projection device 210 to irradiate the unpermitted flying object to which the light projection device 210 is assigned with light.

In a case where one light projection device 210 can irradiate a plurality of unpermitted flying objects with light, and there is no other light projection device 210 capable of irradiating at least one of the plurality of unpermitted flying objects with light, the control unit 180 may switch the unpermitted flying object which the one light projection device 210 irradiates with light. Specifically, the control unit 180 may repeat generation of a control instruction and transmission of the control instruction to the light projection control device 200 in such a way that the unpermitted flying object irradiated by the light projection device 210 among the plurality of unpermitted flying objects is switched according to a predetermined rule.

### Second Modification of Second Example Embodiment

The light projection device 210 may be configured to be able to change a range of light to be radiated. The control unit 180 may change the range of light radiated by the light projection device 210 according to the distance between the position of the unpermitted flying object and the light projection device 210 that irradiates the unpermitted flying object with light. Specifically, the control unit 180 may generate a control instruction including an instruction to control the range of light radiated by the light projection device 210 in such a way that the longer the distance between the position of the unpermitted flying object and the light projection device 210 that irradiates the unpermitted flying object with light, the narrower the range of light radiated by the light projection device 210. The control unit 180 may generate a control instruction including an instruction to control the range of light radiated by the light projection device 210 in such a way that the shorter the distance between the position of the unpermitted flying object and the light projection device 210 that irradiates the unpermitted flying object with light, the wider the range of light radiated by the light projection device 210. The control unit 180 may appropriately set the size of the standard flying object in advance, and determine the range of light radiated by the light projection device in such a way that the flying object having the size is included in the range of light irradiation.

### Third Modification of Second Example Embodiment

The control unit 180 may cause the light projection device 210 not to irradiate the position of the permitted flying object with light but to irradiate the position of the unpermitted flying object with light. Specifically, for example, the control unit 180 selects, from the plurality of light projection devices 210, the light projection device 210 that does not irradiate the position of the unpermitted flying object with light and irradiates the position of the unpermitted flying object with light. More specifically, for example, the control unit 180 may select at least one light projection device 210 from the plurality of light projection devices 210 in such a way that the permitted flying object does not exist within a predetermined distance from a line segment connecting the position of the unpermitted flying object and the position of the selected light projection device 210. The control unit 180 generates a control instruction for instructing the selected light projection device 210 to irradiate the position of the unpermitted flying object with light to transmit the generated control instruction to the light projection control device 200.

### Fourth Modification of Second Example Embodiment

The light projection device 210 may be configured to be able to set at least one (hereinafter, referred to as a setting pattern) of a blinking pattern, a color, brightness, a color switching pattern, and a brightness switching pattern of light to be radiated. The predetermined region may be divided into a plurality of partial regions in advance. A risk level indicating a degree of risk in a case where an unpermitted flying object enters the partial regions may be set in advance in each of the plurality of partial regions. Further, a setting pattern of radiated light may be determined in advance for each risk level.

The control unit 180 causes the light projection device 210 to irradiate the position of the unpermitted flying object with light of a setting pattern according to the risk level of a partial region including the position of the unpermitted flying object. Specifically, the control unit 180 determines a partial region including the position of the unpermitted flying object from the plurality of partial regions described above. The control unit 180 identifies a setting pattern determined for the risk level of a partial region including the position of the unpermitted flying object. The control unit 180 generates a control instruction indicating an instruction to cause the light projection device 210 to irradiate the unpermitted flying object with light of the identified setting pattern. Then, the control unit 180 transmits the generated control instruction to the light projection control device 200 that controls the light projection device 210. As a result, the light projection device 210 irradiates the position of the unpermitted flying object with light of a setting pattern determined for the risk level of the partial region including the position of the unpermitted flying object.

### Fifth Modification of Second Example Embodiment

At least one light projection device 210 may be mounted on the flying object. Then, the light projection control device 200 may control the direction in which the light projection device 210 mounted on the flying object radiates light by controlling the position and the direction of the flying object on which the light projection device 210 is mounted. The light projection control device 200 may be configured to measure the position (for example, latitude and longitude) of the flying object using, for example, a position sensor using a global positioning system (GPS) mounted on the flying object. The flying object may be equipped with a sensor used to measure the height of the flying object. In this case, a reference point whose position (for example, latitude and longitude) and height (for example, elevation) are known and whose distance or the like can be measured from the flying object flying in the predetermined region may be installed. The flying object may be equipped with, for example, a distance meter such as a laser distance meter that measures the distance to such a reference point, or a sensor such as a stereo camera for capturing a stereo image of the reference point for calculating the distance to the reference point. The flying object may be equipped with a sensor such as a stereo camera for capturing a stereo image of a reference point for calculating a direction from the flying object to the reference point. The flying object may calculate the distance to the reference point and the direction from the flying object to the reference point using any of the existing methods, and calculate the height of the flying object from the calculated distance to the reference point and the direction from the flying object to the reference point using any of the existing methods. The flying object may measure the position and the height of the flying object by a method other than the method described above. The light projection control device 200 may be further configured to notify the alert device 100 (specifically, the control unit 180) of the measured position and the measured height of the flying object.

The control unit 180 may select the light projection device 210 that irradiates the position of the unpermitted flying object with light by a method as exemplified below. Then, the control unit 180 may transmit the above-described control instruction including the information about the position of the unpermitted flying object to the light projection control device 200 (that is, the light projection control device 200 that controls the position and the direction of the flying object on which the selected light projection device 210 is mounted) that controls the selected light projection device 210. The light projection control device 200 that has received the control instruction controls the position and the direction of the flying object on which the light projection device 210 is mounted in such a way that the selected light projection device 210 irradiates the position of the unpermitted flying object with light.

The control unit 180 may select the light projection device 210 mounted on the flying object present at the position closest to the position of the unpermitted flying object. The control unit 180 may transmit the above-described control instruction including the information about the position of the unpermitted flying object to the light projection control device 200 that controls the selected light projection device 210.

The control unit 180 may select the light projection device 210 that irradiates the unpermitted flying object with light from the light projection device 210 mounted on the flying object other than the light projection device 210 already controlled to irradiate any other unpermitted flying object with light.

There may be the light projection device 210 mounted on the flying object and the light projection device 210 fixed to the ground. Then, in a case where there is a light projection device 210 fixed on the ground that can irradiate the unpermitted flying object with light within a predetermined distance from the unpermitted flying object, the control unit 180 may select the light projection device 210 as the light projection device 210 that irradiates the unpermitted flying object with light. In a case where there is no light projection device 210 fixed on the ground that can irradiate the unpermitted flying object with light within a predetermined distance from the unpermitted flying object, the control unit 180 may select the light projection device 210 mounted on the flying object as the light projection device 210 that irradiates the unpermitted flying object with light.

### Other Example Embodiments

The alert device 10 and the alert device 100 can be implemented by a computer including a memory loaded with a program read from a storage medium and a processor that executes the program. The alert device 10 and the alert device 100 can also be implemented by dedicated hardware. The alert device 10 and the alert device 100 can also be implemented by a combination of the above-described computer and dedicated hardware.

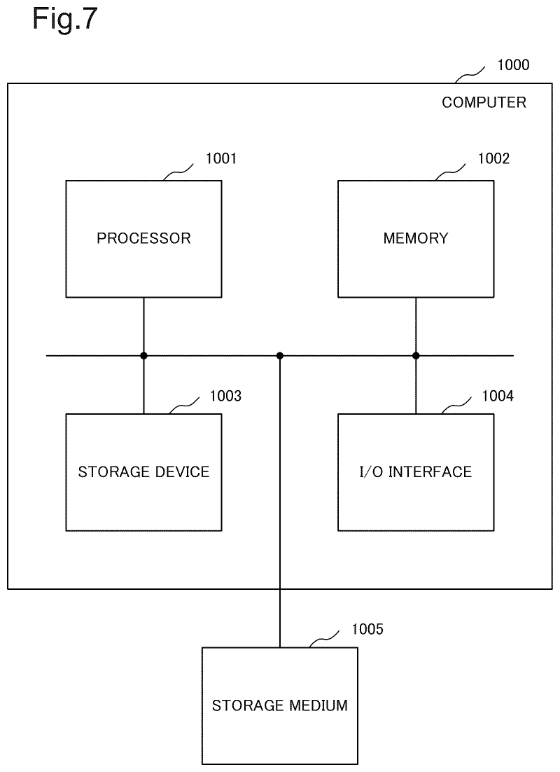

FIG. 7 is a diagram illustrating an example of a hardware configuration of a computer 1000 that can implement the alert device according to the example embodiment of the present disclosure. In the example illustrated in FIG. 7, the computer 1000 includes a processor 1001, a memory 1002, a storage device 1003, and an input/output (I/O) interface 1004. The computer 1000 can access a storage medium 1005. The memory 1002 and the storage device 1003 are, for example, storage devices such as a random access memory (RAM) and a hard disk. The storage medium 1005 is, for example, a storage device such as a RAM or a hard disk, a read only memory (ROM), or a portable storage medium. The storage device 1003 may be the storage medium 1005. The processor 1001 can read and write data and programs from and to the memory 1002 and the storage device 1003. The processor 1001 can access, for example, the sensor and the light projection control device 200 via the I/O interface 1004. The processor 1001 may access the storage medium 1005. The storage medium 1005 stores a program for operating the computer 1000 as the alert device according to the example embodiment of the present disclosure.

The processor 1001 loads, into the memory 1002, a program that is stored in the storage medium 1005 and causes the computer 1000 to operate as the alert device according to the example embodiment of the present disclosure. Then, when the processor 1001 executes the program loaded in the memory 1002, the computer 1000 operates as the alert device according to the example embodiment of the present disclosure.

The measurement data reception unit 110, the position determination unit 120, the specific signal reception unit 130, the specific information determination unit 140, the identification signal reception unit 150, the identification information determination unit 160, the permission determination unit 170, and the control unit 180 can be implemented by, for example, the processor 1001 that executes a program loaded in the memory 1002. Some or all of the measurement data reception unit 110, the position determination unit 120, the specific signal reception unit 130, the specific information determination unit 140, the identification signal reception unit 150, the identification information determination unit 160, the permission determination unit 170, and the control unit 180 can be implemented by a dedicated circuit that implements the functions of the respective units.

Some or all of the above example embodiments may be described as the following Supplementary Notes, but are not limited to the following.

An alert device according to an embodiment of the present disclosure includes a position determination means for identifying, from measurement data of a flying object by a sensor, a position of the flying object, and determining whether the flying object is located within a predetermined region, a specific information determination means for determining whether a signal of a predetermined pattern assigned to a mission within the predetermined region is received from the flying object determined to be located within the predetermined region, a permission determination means for determining, when no signal of the predetermined pattern is received from the flying object, that the flying object is an unpermitted flying object that is not permitted to enter the predetermined region, and a control means for causing a light projection device to irradiate a position of the unpermitted flying object with light.

An alert method according to an embodiment of the present disclosure includes identifying, from measurement data of a flying object by a sensor, a position of the flying object, and determining whether the flying object is located within a predetermined region, determining whether a signal of a predetermined pattern assigned to a mission within the predetermined region is received from the flying object determined to be located within the predetermined region, determining, when no signal of the predetermined pattern is received from the flying object, that the flying object is an unpermitted flying object that is not permitted to enter the predetermined region, and causing a light projection device to irradiate a position of the unpermitted flying object with light.

A storage medium according to an embodiment of the present disclosure stores a program for causing a computer to execute a position determination step for identifying, from measurement data of a flying object by a sensor, a position of the flying object, and determining whether the flying object is located within a predetermined region, a specific information determination step for determining whether a signal of a predetermined pattern assigned to a mission within the predetermined region is received from the flying object determined to be located within the predetermined region, a permission determination step for determining, when no signal of the predetermined pattern is received from the flying object, that the flying object is an unpermitted flying object that is not permitted to enter the predetermined region, and a control step for causing a light projection device to irradiate a position of the unpermitted flying object with light.

While the present disclosure has been particularly illustrated and described with reference to example embodiments thereof, the present disclosure is not limited to these example embodiments. Various modifications that can be understood by those of ordinary skill in the art can be made to the configuration and details of the present disclosure within the scope of the present disclosure.

### REFERENCE SIGNS LIST

10 alert device
100 alert device
110 measurement data reception unit
120 position determination unit
130 specific signal reception unit
140 specific information determination unit
150 identification signal reception unit
160 identification information determination unit
170 permission determination unit
180 control unit
200 light projection control device
210 light projection device
300 sensor unit
310 first sensor
320 second sensor
330 third sensor
1000 computer
1001 processor
1002 memory
1003 storage device
1004 I/O interface
1005 storage medium

What is claimed is:

1. An alert device comprising:
at least one memory storing a set of instructions; and
at least one processor configured to execute the set of instructions to:
identify, from measurement data of a flying object by a sensor, a position of the flying object;
determine whether the flying object is located within a predetermined region;
determine whether a signal of a predetermined pattern assigned to a mission in the predetermined region is received from the flying object determined to be located within the predetermined region;
determine, in a case where no signal of the predetermined pattern is received from the flying object, that the flying object is an unpermitted flying object that is not permitted to enter the predetermined region; and
cause a light projection device to irradiate a position of the unpermitted flying object with light.

2. The alert device according to claim 1, wherein
the flying object to which the mission is given is configured to transmit a signal of the predetermined pattern assigned to the mission,
the at least one processor is further configured to execute the instructions to:
determine, in a case where the signal of the predetermined pattern is received from the flying object, that the flying object is a permitted flying object permitted to enter the predetermined region; and
cause the light projection device not to irradiate a position of the flying object determined to be the permitted flying object.

3. The alert device according to claim 2, wherein
the predetermined pattern is assigned in advance individually to the mission of the flying object in the predetermined region.

4. The alert device according to claim 1, wherein
the at least one processor is further configured to execute the instructions to
receive an identification signal indicating flying object identification information that is an identifier of the flying object, the identification signal being transmitted from the flying object.

5. The alert device according to claim 4, wherein
the at least one processor is further configured to execute the instructions to
determine the flying object indicated by the flying object identification information as the unpermitted flying object in a case where the flying object identification information indicated by the detected identification signal is not included in a working flying object list that is a list of flying object identification information about a flying object to which a mission in the predetermined region is assigned.

6. The alert device according to claim 1, wherein
the flying object includes a predetermined shaped reflection site that emits light when irradiated with light of a predetermined wavelength, and
the at least one processor is further configured to execute the instructions to
detect the predetermined shaped reflected light, as the signal of the predetermined pattern, from an image of the flying object irradiated with the light of the predetermined wavelength.

7. The alert device according to claim 1, wherein
the light projection device is mounted on another flying object.

8. An alert method comprising:
identifying, from measurement data of a flying object by a sensor, a position of the flying object, and determining whether the flying object is located within a predetermined region;
determining whether a signal of a predetermined pattern assigned to a mission in the predetermined region is received from the flying object determined to be located within the predetermined region;
determining, in a case where no signal of the predetermined pattern is received from the flying object, that the flying object is an unpermitted flying object that is not permitted to enter the predetermined region; and
causing a light projection device to irradiate a position of the unpermitted flying object with light.

9. The alert method according to claim 8, wherein
the flying object to which the mission is given is configured to transmit a signal of the predetermined pattern assigned to the mission, and
the alert method further comprises:
determining, in a case where the signal of the predetermined pattern is received from the flying object, that the flying object is a permitted flying object permitted to enter the predetermined region; and
causing the light projection device not to irradiate a position of the flying object determined to be the permitted flying object.

10. The alert method according to claim 9, wherein
the predetermined pattern is assigned in advance individually to the mission of the flying object in the predetermined region.

11. The alert method according to claim 8, further comprising
receiving an identification signal indicating flying object identification information that is an identifier of the flying object, the identification signal being transmitted from the flying object.

12. The alert method according to claim 11, further comprising
determining the flying object indicated by the flying object identification information as the unpermitted flying object in a case where the flying object identification information indicated by the detected identification signal is not included in a working flying object list that is a list of flying object identification information about a flying object to which a mission in the predetermined region is assigned.

13. The alert method according to claim 8, wherein
the flying object includes a predetermined shaped reflection site that emits light when irradiated with light of a predetermined wavelength, and
the alert method further comprises
detecting the predetermined shaped reflected light, as the signal of the predetermined pattern, from an image of the flying object irradiated with the light of the predetermined wavelength.

14. The alert method according to claim 8, wherein
the light projection device is mounted on another flying object.

15. A non-transitory computer readable storage medium storing a program for causing a computer to execute:
position determination processing of identifying, from measurement data of a flying object by a sensor, a position of the flying object, and determining whether the flying object is located within a predetermined region;
specific information determination processing of determining whether a signal of a predetermined pattern assigned to a mission in the predetermined region is received from the flying object determined to be located within the predetermined region;
permission determination processing of determining, in a case where no signal of the predetermined pattern is received from the flying object, that the flying object is an unpermitted flying object that is not permitted to enter the predetermined region; and
control processing of causing a light projection device to irradiate a position of the unpermitted flying object with light.

16. The non-transitory computer readable storage medium according to claim 15, wherein
the flying object to which the mission is given is configured to transmit a signal of the predetermined pattern assigned to the mission,
the permission determination processing determines, in a case where the signal of the predetermined pattern is received from the flying object, that the flying object is a permitted flying object permitted to enter the predetermined region, and
the control processing causes the light projection device not to irradiate a position of the flying object determined to be the permitted flying object.

17. The non-transitory computer readable storage medium according to claim 16, wherein
the predetermined pattern is assigned in advance individually to the mission of the flying object in the predetermined region.

18. The non-transitory computer readable storage medium according to claim 15, the program causing a computer to execute
identification signal reception processing of receiving an identification signal indicating flying object identification information that is an identifier of the flying object, the identification signal being transmitted from the flying object.

19. The non-transitory computer readable storage medium according to claim 18, wherein
the permission determination processing determines the flying object indicated by the flying object identification information as the unpermitted flying object in a case where the flying object identification information indicated by the detected identification signal is not included in a working flying object list that is a list of flying object identification information about a flying object to which a mission in the predetermined region is assigned.

20. The non-transitory computer readable storage medium according to claim 15, wherein
the flying object includes a predetermined shaped reflection site that emits light when irradiated with light of a predetermined wavelength, and
the specific information determination processing detects the predetermined shaped reflected light as the signal of the predetermined pattern from an image of the flying object irradiated with the light of the predetermined wavelength.

21. (canceled)
